(19) United States
(12) Patent Application Publication
(10) Pub. No.: US 2006/0161446 A1
(43) Pub. Date: Jul. 20, 2006

(54) System, method, and computer program product for accessing electronic tickets by paper-based travel service provider

(75) Inventors: Neil Fyfe, Richardson, TX (US); Gary Millward, Trophy Club, TX (US); George Heil, Keller, TX (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Sabre Inc., Southlake, TX (US)

(21) Appl. No.: 11/039,213

(22) Filed: Jan. 19, 2005

(51) Int. Cl. G06Q 99/00

(52) U.S. Cl. 705/1

(57) ABSTRACT

A system, method, and computer program product receive a first request document using a first format at an intermediate location in response to a request by a paper-based travel service provider to access an electronic ticket, convert the first request document to a second request document using a second format, and transmit the second request document to an electronic ticket database to thereby direct the electronic ticket database to access the electronic ticket in response to the second request document. In one embodiment, the first format is XML and the second format is EDIFACT. The system, method, and computer program product of the present invention thereby allow a paper-based travel service provider to access an electronic ticket through an Internet application interfacing with another travel service provider's electronic ticketing system.

### FIELD OF THE INVENTION

The present invention relates generally to electronic ticketing, and more particularly, to systems, methods, and computer program products for accessing electronic tickets by carriers with paper-based ticketing systems.

### BACKGROUND OF THE INVENTION

Many types of businesses provide travel services. For example, airlines, bus lines, cruise lines, and railroads all transport passengers. Other businesses provide other travel-related services, such as car rentals and lodging. Businesses that provide travel services, in particular those that transport passengers (such businesses are termed carriers), may sell their services to customers using tickets. The customer may purchase a ticket, which the customer then exchanges at a later date for the travel service. These carriers, in particular airlines, use several methods of selling tickets to their passengers. Airlines sell tickets directly to passengers and through third-parties such as travel agencies. The tickets that are sold can either be paper tickets or electronic tickets.

When an airline sells a paper ticket directly to a passenger, the airline uses a ticket form that is preprinted with the name of the airline. On the ticket form, the airline would print information such as the passenger's name, the date and time of travel, the price of the ticket, and the origin and destination airports. To be able to sell paper tickets, a travel agency has a supply of blank tickets that can be used to create tickets that are valid on many different airlines. The travel agency would print the specific airline's name on the ticket, as well as the passenger's name, the date and time of travel, the price of the ticket, and the origin and destination airports. The passenger is given the paper ticket, which the passenger brings to the airport on the day of travel. The ticket may actually consist of one or more flight coupons, with the passenger getting one flight coupon for every separate flight on which the passenger is traveling. The flight coupon is given to the airline and the passenger is allowed to board the airplane.

The travel agency reports the sold tickets to one of the Billing and Settlement Plans (BSPs). The BSPs are third-parties that are responsible for transferring money between travel agencies and airlines when a travel agency sells a ticket for an airline. For example, when the travel agency sells a ticket on Alpha Airlines, the travel agency collects the money for that ticket from the purchasing passenger and a BSP transfers the money from the travel agency to Alpha Airlines. The airline for which the ticket is printed and which receives the money from the sale of the ticket is termed the validating or plating airline.

There are approximately seventy BSPs worldwide, with each BSP handling money transfers for tickets sold within a specific country or region. For example, the BSP that handles money transfers for tickets sold in the United States is the Airlines Reporting Corporation (ARC). In order to transfer money to or receive a money transfer from a specific BSP, the travel agency and the airline must have a membership in that specific BSP. Travel agencies and airlines must pay membership fees to each BSP to which they belong. Therefore, a travel agency would typically only belong to the BSP in the country/region where the travel agency is located, and an airline would typically only belong to those BSPs in the countries/regions where the airline flies.

Not every airline flies passengers in and out of every airport worldwide, therefore passengers may need to travel on two or more different airlines to get to their desired destination. For example, a passenger may desire to travel from a large city in one country to a small city in another country. This passenger may travel from the large city in the first country to a large city in the second country on a large international airline, and then transfer to a smaller regional airline to travel from the large city in the second country to the small city in the second country. Often in these circumstances both flights may be plated to one of the airlines. When a passenger purchases a ticket plated to one airline but for travel on a different airline, this is termed interline (i.e., between airlines) travel. When a travel agency sells an interline ticket, one of the airlines is established as the plating or validating airline. The other airline may be called the operating airline. The full value of the ticket is transferred by the BSP from the travel agency to the plating airline. The passenger would be given a flight coupon for the flight on the plating airline and a flight coupon for the flight on the operating airline. The passenger gives the appropriate flight coupon to the operating airline when the passenger boards that flight. The operating airline returns the flight coupon to the plating airline, at which point the plating airline will transfer a portion of the ticket price to the operating airline. The transfer of money from the plating airline to the operating airline is conducted through a special interline funds clearinghouse. All airlines are members of this interline funds clearinghouse, even if they are not a member of a BSP.

The process of selling an electronic ticket to a passenger is similar to the process of selling a paper ticket, but no physical flight coupons are issued for an electronic ticket. Rather, a virtual coupon record (VCR) is created. Selling an electronic ticket typically involves a Global Distribution System (GDS). The various GDSs, such as Sabre, Amadeus, Galileo, and WorldSpan, act as middlemen to sell airline tickets through various customer channels, such as travel agencies and travel planning websites. When a travel agency books a ticket through a GDS, the ticket is plated or validated to the airline by means of an electronic message sent from the GDS to the airline. The electronic message uses the EDIFACT (Electronic Data Interchange for Administration, Commerce and Transport) protocol. Once an electronic ticket is issued, the financial tracking and status tracking/changes are handled within the airline's electronic ticketing system. Some of the potential statuses that an electronic ticket may have are: open, flown, exchanged, refunded, or voided.

Electronic tickets may also be created for interline travel. Similar to paper tickets, the entire ticket is plated to one airline and resides in the plating airline's electronic ticketing system. The operating airline is given control of the VCR for its portion of the ticket, such that the operating airline can access the VCR in order to view the VCR and change its status. The operating airline accesses the VCR by sending EDIFACT messages from the operating airline's electronic ticketing system to the plating airline's electronic ticketing system. An electronic ticketing hub may be used to route the EDIFACT messages among various airlines, such that the electronic ticketing hub receives EDIFACT messages from many different airlines and forwards each message to the appropriate airline. The electronic ticketing hub may also translate messages from one version of EDIFACT to another version, such that airline electronic ticketing systems that use different versions of EDIFACT are able to communicate.

As in a paper ticket, when an interline electronic ticket is created the full value of the ticket is transferred by the BSP from the travel agency to the plating airline. Unlike with a paper ticket, the operating airline does not have to return a flight coupon to receive its share of the ticket price. As soon as the status of the VCR for the interline portion of the travel is changed to “flown” (via an EDIFACT message from the electronic ticketing system of the operating airline to the electronic ticketing system of the plating airline), the plating airline transfers a portion of the ticket price to the operating airline. As such, the operating airline may receive its portion of the price of an electronic ticket quickly.

Because an airline can only receive money transferred from a BSP to which the airline belongs, a different solution may be required when a travel agency needs to purchase a ticket on an airline that does not belong to the same BSP as the travel agency. For example, a travel agency in Europe may be arranging an extensive trip for a customer to several countries in South America. The airline for the flight from Europe to South America would likely belong to the same BSP as the travel agency. However, the flights from country to country within South America may be on an airline that only flies within South America and which therefore does not belong to the same BSP as the travel agency. The European travel agency in this example needs a way to purchase a ticket on such an airline. Such an airline may be termed a non-BSP airline (while the South American airline likely belongs to one or more BSPs, it does not belong to the BSP to which this particular travel agency belongs).

One method a travel agency can use to purchase tickets on a non-BSP airline is to use the standard interline ticketing process. In the example above, if the airline on which the passenger is flying from Europe to South America belongs to the same BSP as the travel agency, then the entire ticket can be plated to that airline. As such, the South American airline will receive its portion of the ticket price from the European airline. However, there are circumstances where it may not be possible to use the standard interline ticketing process. For example, if the two airlines have not entered into an interline agreement it will not be possible to use the interline ticketing process. There may also be circumstances where, while it may be possible to use the interline ticketing process, it may not be desirable. For example, it may be less expensive to purchase the tickets separately as compared to purchasing them together through the plating airline.

In those circumstances where a travel agency needs to purchase tickets on a non-BSP airline and it is not possible or desirable to use the standard interline ticketing process, another option is available. The travel agency can plate the ticket to a third party (often termed a virtual airline) for a flight on a non-BSP airline. The virtual airline charges a fee to the non-BSP airline for providing this service. This is similar to an interline ticket, in that travel on one airline (the non-BSP airline) is plated to another airline (the virtual airline). Unlike typical interline tickets, however, the passenger is not traveling at all on the plating airline. The virtual airline will typically be a member of a large number of BSPs, and will have interline agreements in place with a large number of airlines. Therefore, a travel agency is likely to be able to plate tickets through the virtual airline for most non-BSP airlines. The virtual airline will receive payment from the travel agency through the BSP to which the travel agency belongs, and the virtual airline will transfer payment to the non-BSP airline through the interline funds clearinghouse. The timing of the transfer of payment from the virtual airline to the non-BSP airline depends on whether a paper ticket or an electronic ticket is used.

Where the non-BSP airline has the capability to support electronic tickets, the ticket is plated to the virtual airline as an electronic ticket (i.e., a VCR). When the passenger arrives at the airport to check-in with the non-BSP airline, the non-BSP airline is able to access the VCR through its electronic ticketing system by sending an EDIFACT message to the virtual airline's electronic ticketing system. When the non-BSP airline's electronic ticketing system changes the status of the VCR to “flown,” the payment for the ticket is transferred to the non-BSP airline through the interline funds clearinghouse. Thus, the non-BSP airline quickly receives its payment.

When the ticket is plated to the virtual airline as an electronic ticket, the non-BSP airline is able to make any necessary changes to the ticket by accessing the VCR through the non-BSP's electronic ticketing system.

Where the non-BSP airline does not have the capability to support electronic tickets (such an airline may be termed a paper-based airline), the ticket is plated to the virtual airline as a paper ticket and the passenger is given a paper flight coupon. When the passenger arrives at the airport to check-in with the non-BSP airline, the non-BSP airline takes the flight coupon from the passenger. The flight coupon must be returned to the virtual airline, and the non-BSP airline does not receive payment for the ticket until the virtual airline receives the flight coupon. Once the virtual airline receives the flight coupon, the payment for the ticket is transferred to the non-BSP airline through the interline funds clearinghouse. Thus, the non-BSP airline will typically wait several days to receive its share of the ticket price.

When the ticket is plated to the virtual airline as a paper ticket, the non-BSP airline is able to make any necessary changes to the ticket by retrieving the original paper ticket from the passenger and issuing a new paper ticket.

The current process of using a virtual airline to purchase tickets on a non-BSP airline works for non-BSP airlines regardless of whether the non-BSP airline has the capability to support electronic ticketing. However, starting in 2007, BSPs will no longer be allowed to process payments involving paper tickets. Since the virtual airline receives its payments from travel agencies through BSPs, the virtual airline will no longer be able to accept orders for paper tickets. This change will mean that the current process of using a virtual airline to purchase tickets on a non-BSP airline will no longer work for paper-based non-BSP airlines. These paper-based non-BSP airlines could implement their own electronic ticketing process, thereby allowing them to continue to use a virtual airline to receive electronic ticket orders from travel agencies belonging to other BSPs. However, implementing an electronic ticketing process is expensive and time-consuming, and is therefore not feasible for many small airlines.

As such, there is a need for a system, method, and computer program product for complying with the mandate that BSPs will not process payments involving paper tickets, while still continuing to use virtual airlines to purchase tickets from paper-based, non-BSP airlines. Additionally, it would be desirable to provide a paper-based, non-BSP airline with increased flexibility in terms of changing a ticket.

### BRIEF SUMMARY OF THE INVENTION

A system, method, and computer program product are therefore provided that include embodiments that address the foregoing and other limitations of the conventional approach by receiving a first request document in a first format at an intermediate location in response to a request by a paper-based airline to access an electronic ticket, converting the first request document to a second request document in a second format, and transmitting the second request document from the intermediate location to an electronic ticket database to thereby direct the electronic ticket database to access the electronic ticket in response to the second request document. In one embodiment, the first format is XML and the second format is EDIFACT. The system, method, and computer program product of one embodiment of the present invention thereby allow a paper-based airline to access an electronic ticket through an Internet application interfacing with a virtual airline's electronic ticketing system.

In one embodiment of the invention, after receiving the second request document the electronic ticket database creates a first response document using the second format and transmits the first response document. The present invention thereafter receives the first response document from the electronic ticket database, converts the first response document to a second response document using the first format, and transmits the second response document to the paper-based carrier. The first response document and the second response document would typically each comprise electronic ticket data, such as passenger and flight information.

In one embodiment of the invention, the request by the paper-based carrier comprises at least one search term, such that the electronic ticket database uses the search term to access the electronic ticket. Such a search term would allow the paper-based carrier to search for and thereby access an electronic ticket in a number of different ways.

The system, method, and computer program product of the present invention may display the electronic ticket data received from the electronic ticket database. In one embodiment, the electronic ticket data may be displayed as a facsimile of a paper ticket. As the gate agents and other personnel working for the paper-based carriers are accustomed to viewing paper tickets, this minimizes the training that may need to be provided to the personnel.

In one embodiment of the invention, the first request document may be received in response to a request by the paper-based carrier to change a status of the electronic ticket. As such, the first request document and the second request document would each comprise instructions to change the status of the electronic ticket, and the electronic ticket database would change the status of the electronic ticket in response to the second request document.

In one embodiment of the invention, the first request document is received in response to a request by the paper-based carrier to change a status of each of a plurality of electronic tickets, and therefore the first request document may be converted to a plurality of second request documents. As such, the first request document and the second request documents would each comprise instructions to change the status of the electronic ticket, and the electronic ticket database would change the status of each of the plurality of electronic tickets in response to the plurality of second request documents. This would allow the paper-based carrier to change the status of many electronic tickets at one time. The plurality of electronic tickets may all correspond to one flight of the paper-based carrier, and, in one embodiment, the present invention may require the paper-based carrier to change the status of each of the plurality of electronic tickets after the departure of the flight.

The foregoing embodiments of the present invention involve “pulling” the electronic ticket data. As such, the electronic ticket data is accessed from the electronic ticket database only after a request by the paper-based carrier. Other embodiments of the invention may involve “pushing” the electronic ticket data from the electronic ticket database. For example, the electronic ticket data for flights scheduled for a particular day may be sent out from the electronic ticket database on that day, prior to being requested by the airline personnel. As such, a system, method, and computer program product are therefore provided that receive electronic ticket data in a first format at an intermediate network location from an electronic ticket database, convert the electronic ticket data from the first format to a second format, receive a request document in the second format at the intermediate network location in response to a request by the paper-based carrier to access the electronic ticket data, access the electronic ticket data at the intermediate network location in response to the request document, create a response document comprising the electronic ticket data in the second format, and transmit the response document from the intermediate network location to the paper-based carrier. In one embodiment, the first format is EDIFACT and the second format is XML. The system, method, and computer program product of the present invention allow the electronic ticket data to be transmitted to the intermediate network location and converted to the format for transmission to the paper-based carrier on the day it is likely to be accessed, thereby allowing faster access to the data in response to the request document.

In addition to the method for accessing electronic tickets described above, other aspects of the present invention are directed to corresponding systems and computer program products for accessing electronic tickets.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a flowchart of the operation of accessing electronic tickets by a paper-based carrier, according to one embodiment of the present invention;

FIG. 2 is a flowchart of the operation of accessing electronic tickets by a paper-based carrier, according to one embodiment of the present invention; and

FIG. 3 is a schematic block diagram of a system for accessing electronic tickets by a paper-based carrier, according to one embodiment of the present invention.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

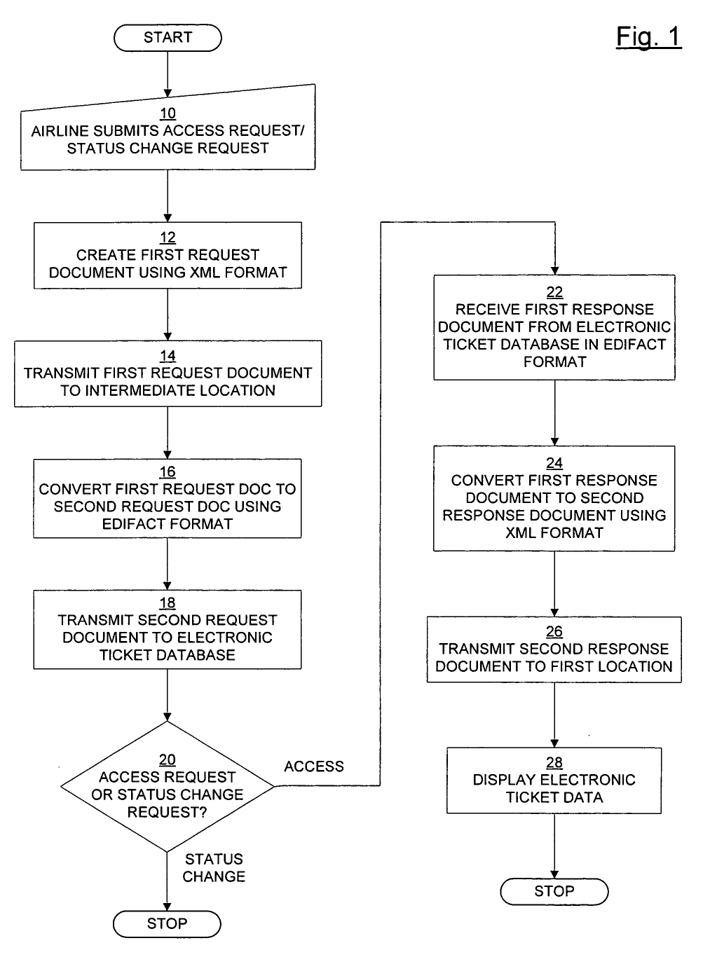

FIG. 1 is a flowchart of the operations performed by a method for accessing electronic tickets by a paper-based carrier, according to one embodiment of the present invention. While embodiments of the present invention will be described in terms of an airline ticketing system for purposes of explanation, it should be appreciated that the present invention may be used in any type of passenger transportation system, in any type of travel services ticketing system, or in any ticketing system utilizing electronic and paper-based documents.

FIG. 1 represents an embodiment of the present invention that involves “pulling” the electronic ticket data from the electronic ticket database. As shown in block 10 of FIG. 1, a paper-based airline submits a request to access or change the status of one or more electronic tickets. This request would typically be submitted by airline personnel, such as a ticket agent or a gate agent, or by personnel of a third party ground handler contracted by the paper-based airline. The personnel may request to access an electronic ticket in order to view the ticket data, such as the passenger name and flight number. The personnel may request to change the status of an electronic ticket. Airline personnel may need to change the status of a ticket for a number of reasons. For example, the personnel will typically change the status of a particular ticket after a flight has departed to indicate that the particular ticket has been used. Additionally, when the non-BSP airline personnel need to make a change to a ticket, the airline personnel can change the status of the ticket to “exchanged” and then issue a new paper ticket. The request may be to access or change the status of several tickets at one time. For example, after a flight has departed the personnel may desire to update the status of all the electronic tickets associated with that flight.

The airline personnel may submit the request via a graphical user interface (GUI), which would typically be created using an object-oriented programming language, such as Java or C++, and would run on a personal computer (PC). The GUI would typically have several screens, allowing the personnel to select the type of request to be submitted. For example, the GUI would typically present different screens to the personnel depending upon whether the personnel is submitting a request to access an electronic ticket or a request to change the status of an electronic ticket.

In one embodiment, access to the GUI may be password controlled, with different levels of permission for different tasks. For example, all airline personnel may be allowed to access electronic tickets, but only airline supervisors may be allowed to change the status of an electronic ticket to “voided.”

The personnel would typically enter one or more search terms, such as the passenger's surname, the flight number, or the passenger's frequent flyer number, to access or change an electronic ticket. In one embodiment, the Java application may require the airline personnel to enter a status for every electronic ticket on a particular flight. For example, after the flight has departed, the airline personnel may be required to indicate for every electronic ticket whether or not the passenger checked in, thereby ensuring that every electronic ticket is properly accounted.

After the airline personnel has entered the request via the GUI, the Java application would create a first request document, as shown in block 12. The first request document would typically be created using Extensible Markup Language (XML) format, but may be created using any suitable markup language or any other suitable format as known to those skilled in the art. The specific content of the XML document would typically vary depending on whether an access request or a status change request has been submitted, but would include sufficient information for the electronic ticket to be identified and any requested status change to be performed.

After the first request document has been created, the next step would typically be to transmit the first request document from the PC across a network to an intermediate network location, as shown in block 14. This intermediate network location would typically be a web server, but may generally be any other suitable server or computer.

The next step would typically be to convert the first request document into a second request document using the EDIFACT format, as shown in block 16. The EDIFACT format is generally the required format for communicating with an electronic ticket database. Once the second request document has been created using the EDIFACT format, it may be transmitted to the electronic ticket database, as shown in block 18. It should be appreciated that, if the request by the airline personnel was to access or change multiple electronic tickets, then multiple second request documents (i.e., one for each electronic ticket to be accessed/changed) would generally be created.

The next step would typically depend on whether an access request or a status change request was submitted, as determined in block 20. If the request documents comprised a status change request, then the electronic ticket database would typically perform the requested status change. However, no return or confirmation message would typically be sent from the electronic ticket database so no further action would be taken by the system, method, and computer program product of the present invention.

If the request documents comprised an access request, then the electronic ticket database would access the desired electronic ticket, create a first response document containing the electronic ticket data in EDIFACT format, and transmit the first response document back to the intermediate network location. The first response document would be received at the intermediate network location, as shown in block 22. Again, it should be appreciated that, if the request by the airline personnel was to access multiple electronic tickets, then multiple first response documents (i.e., one for each electronic ticket to be accessed) would generally be created.

After receiving the first response document in EDIFACT format, the intermediate network location would typically be converted into a second response document in XML format, as shown in block 24. The second response document would typically then be transmitted to the PC running the Java application at the airline location, as shown in block 26. If there were multiple first response documents because of multiple access requests, these multiple first response documents would typically be combined into one second response request comprising the electronic ticket data from all of the first response documents.

Finally, the Java application would display the electronic ticket data to be viewed by the airline personnel, as shown in block 28. In one embodiment, a facsimile of a paper ticket may be displayed by the Java application. As the airline personnel are accustomed to viewing paper tickets, this may reduce the training required for the personnel to use the present invention.

The method for accessing electronic tickets by a paper-based carrier illustrated in FIG. 1 enables a paper-based carrier to access and change the status of electronic tickets that were plated to a virtual airline, without having to incur the expense to implement an electronic ticketing system. This method also allows travel agencies to continue to place ticket orders, and BSPs to continue to process payments, for flights on a paper-based, non-BSP airline by providing a method whereby the paper-based, non-BSP airline can quickly and inexpensively utilize electronic tickets. Therefore, the method of the present invention complies with the mandate that BSPs cannot process payments involving paper tickets beginning in 2007, while continuing to allow travel agencies to use virtual airlines to purchase tickets from a paper-based, non-BSP airline.

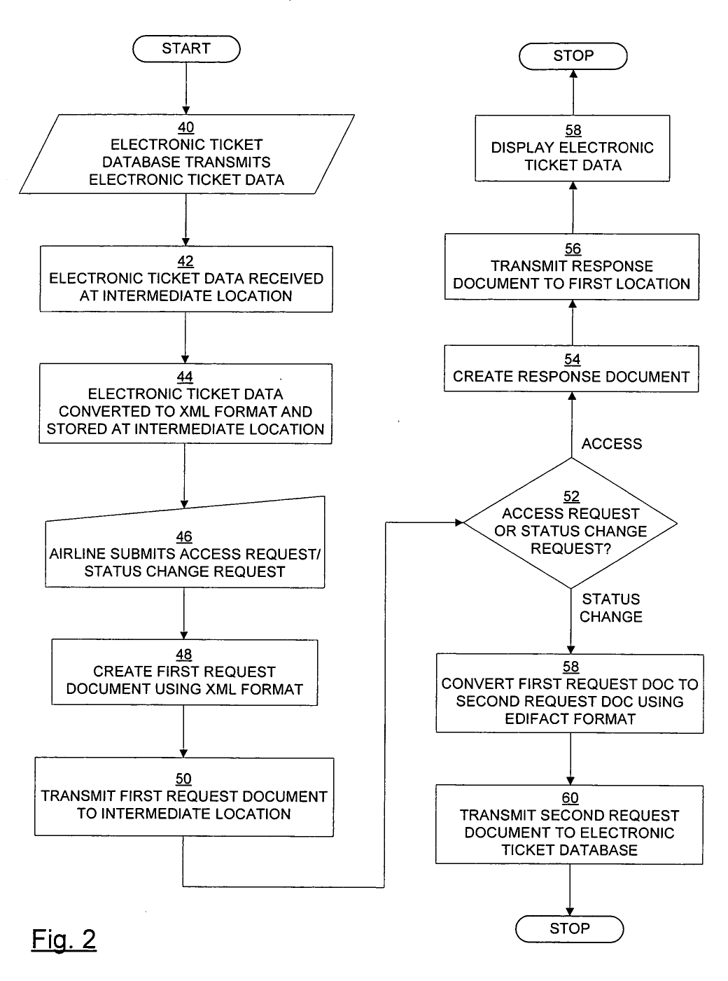

FIG. 2 is a flowchart of the operations performed by another method for accessing electronic tickets by a paper-based carrier, according to one embodiment of the present invention that involves “pushing” the electronic ticket data by the electronic ticket database. As shown in block 40, the electronic ticket database transmits electronic ticket data in EDIFACT format to the intermediate network location. In one embodiment, the electronic ticket database may transmit this data on a periodic basis, such as daily. The data for all flights scheduled for a particular day may be transmitted to the intermediate network location at the beginning of that day. As such, only the data likely to be accessed on a particular day would be at the intermediate network location. It should be appreciated, however, that how often the data is pushed, as well as how much data is pushed each time, may vary depending on the requirements of the carrier. For example, the data could be sent several days in advance of the flight date. Whenever the data for a particular flight is pushed in advance of the flight, there is a possibility that a passenger will purchase a ticket after the data has been pushed. For this reason, the present invention will typically provide the ability to push data for ticket sales which occur after the data for a particular flight has been pushed, in order to update the data with the latest passenger information. Pushing the data to the intermediate network location may allow the personnel of the paper-based airline to more quickly access the data, because there is likely to be a smaller amount of data to search at the intermediate network location and fewer network connections must be traversed to access the data.

In a typical embodiment of the invention, the paper-based airline would have control of the data once it has been pushed to the intermediate network location. As such, the ticket data at the electronic ticket database is locked, and only the paper-based airline is permitted to modify the data (i.e., the paper-based airline has control of the data). The electronic ticket database does not have control again until the data is released back by the airline. Several types of actions by the paper-based carrier may release control of the data back to the electronic ticket database. For example, when the paper-based carrier changes the status of an electronic ticket, control of that ticket is passed back to the electronic ticket database. In one embodiment of the invention, the paper-based airline may have the capability to select a flight that has been cancelled. The present invention would then typically identify all electronic tickets sold for the cancelled flight, submit a request to change the status of all the tickets to “cancelled,” and release control of all the tickets back to the electronic ticket database.

As shown in block 42, the electronic ticket data is received by the intermediate network location. The data is then typically converted into XML format and stored at the intermediate network location for potential later access by the airline, as shown in block 44. Converting the electronic ticket data to XML format prior to a request by the airline to access the data further enables quicker access to the data. It should be appreciated that XML format is used throughout for example purposes only, and that any suitable markup language may be used. Alternatively, the data could be stored in any format at the intermediate network location, thus the data may not be converted until it is requested by the airline. In another alternative embodiment using a traditional application program interface (API) approach, the data could reside in its native format at the intermediate network location and be rendered by the GUI upon request by the airline, without XML or any secondary format being used.

After the electronic ticket data is converted to XML and stored at the intermediate network location, the next step is typically for airline personnel to submit an access request or a status change request, as shown in block 46. This process is discussed in detail above. As discussed above and shown in block 48, the Java application will typically create a first request document in XML, or another suitable markup language, format. The Java application will then typically transmit the first request document to the intermediate network location, as shown in block 50.

The next step would typically depend on whether an access request or a status change request was submitted, as determined in block 52. If the request documents comprised an access request, then the intermediate network location would access the desired electronic ticket and create a response document containing the electronic ticket data in XML format, as shown in block 54. Then the response document would be transmitted to the PC running the Java application at the airline location, as shown in block 56. Finally, the Java application would display the electronic ticket data to be viewed by the airline personnel, as shown in block 58. As discussed above, a facsimile of a paper ticket may be displayed by the Java application if desired.

If the request documents comprised a status change request, then the next step would typically be to convert the first request document into a second request document using the EDIFACT format, as shown in block 58. Once the second request document has been created using the EDIFACT format, it may be transmitted to the electronic ticket database, as shown in block 60. The electronic ticket database would then typically perform the requested status change. However, no return or confirmation message would typically be sent from the electronic ticket database so no further action would be taken by the system, method, and computer program product of the present invention.

As in the method illustrated in FIG. 1, the method for accessing electronic tickets by a paper-based carrier illustrated in FIG. 2 also enables a paper-based carrier to access and change the status of electronic tickets that were plated to a virtual airline, without having to incur the expense to implement an electronic ticketing system. This method also allows travel agencies to continue to place ticket orders, and BSPs to continue to process payments, for flights on a paper-based, non-BSP airline by providing a method whereby the paper-based, non-BSP airline can quickly and inexpensively utilize electronic tickets. Therefore, the method of the present invention complies with the mandate that BSPs cannot process payments involving paper tickets beginning in 2007, while continuing to allow travel agencies to use virtual airlines to purchase tickets from a paper-based, non-BSP airline. The method illustrated in FIG. 2 may enable the paper-based, non-BSP airline to access the electronic ticket data more quickly, as the data has been pushed to an intermediate location prior to the data being requested by the airline.

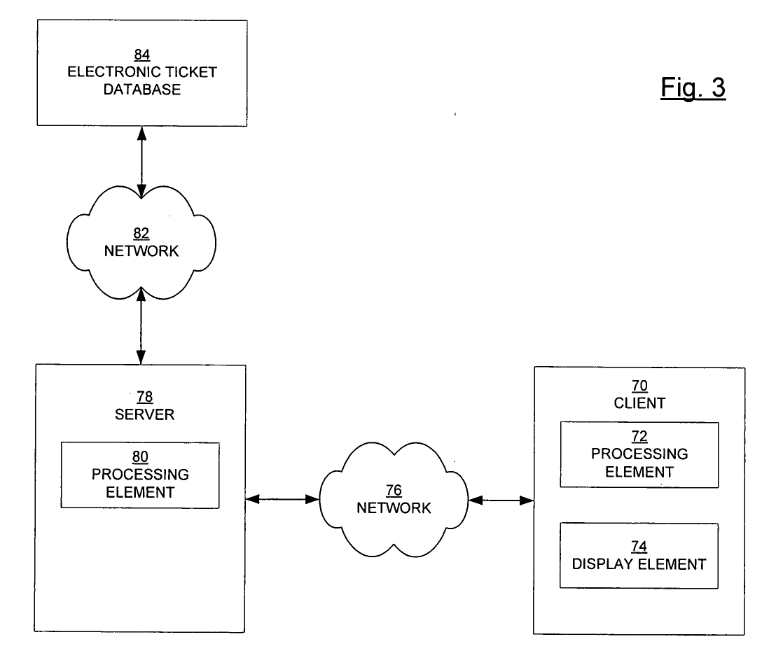

FIG. 3 is a schematic block diagram of a system for accessing electronic tickets by a paper-based carrier, according to one embodiment of the present invention. FIG. 3 illustrates a system using a client/server configuration. In the exemplary system of FIG. 2, server 78 comprises processing element 80, and client 70 comprises processing element 72 and display element 74. Server 78 and client 70 are in communication across network 76. Server 78 is in communication with electronic ticket database 84 across network 82. Client 70 would typically comprise a PC at a location readily accessible to personnel of the paper-based airline, such as at a ticket counter of an airport. Client 70 would typically host a Java application to provide the GUI used by the airline personnel to submit a request to access or change the status of an electronic ticket. Server 78 would typically comprise a web server at an intermediate network location. Although not shown in FIG. 3, server 78 would typically be connected to and receive requests from a number of clients at a number of locations, thereby providing support for multiple paper-based airlines with multiple locations. Server 78 may also be connected to more than one electronic ticket database, thereby providing support for more than one virtual airline.

It should be appreciated that client 70, server 78, and electronic ticket database 84 may all be physically located in separate locations, or may be co-located. For example, server 78 and electronic ticket database may be physically located in the same location. It should also be appreciated that, while client 70, server 78, and electronic ticket database 84 are shown in FIG. 3 as separate components, two or more of these functions may be combined into one component.

Processing element 72 of client 70 creates a first request document, typically in XML format, in response to a request by personnel of the paper-based carrier to access an electronic ticket. Processing element 72 then transmits the first request document, via network 76, to server 78 at an intermediate network location. Network 76 may be any suitable network, such as the Internet.

Processing element 80 of server 78 converts the first request document to a second request document in EDIFACT format. Processing element 80 then transmits the second request document from the intermediate network location to electronic ticket database 84, via network 82. As discussed above, if the request by the airline personnel is to access or change more than one electronic ticket, then processing element 80 would generally convert the first request document into more than one second request documents. Network 82 may be any suitable network, such as the Internet. In one embodiment, the second request document may be transmitted through an electronic ticket hub, which may direct the second request document to the appropriate one of several electronic ticket databases.

After receiving the second request document, the actions performed by electronic ticket database 84 will vary depending on whether the request is to access an electronic ticket or to change its status. If the request is to change the status of an electronic ticket, electronic ticket database 84 will then typically perform the requested status change. However, no return or confirmation message would typically be sent from electronic ticket database 84.

If the request is to access an electronic ticket, electronic ticket database 84 accesses the electronic ticket in response to the second request document and retrieves the electronic ticket data contained in the electronic ticket. Electronic ticket database 84 would then typically create a first response document in EDIFACT format and transmit the first response document to the intermediate network location. Then processing element 80 would receive the first response document and convert the first response document to a second response document in XML format. Processing element 80 would then transmit the second response document to client 70 such that display element 74 could display the electronic ticket data for the airline personnel.

While FIG. 3 illustrates a system of the present invention using a client/server configuration, it should be appreciated that the client/server configuration is shown for example purposes only and that they system of the present invention could utilize configurations other than client/server. It should also be appreciated that the overall system architecture shown in FIG. 3 is for example purposes only, and not intended to limit the scope of the present invention. The system of the present invention could be implemented using a number of different system configurations.

The method of accessing electronic tickets by a paper-based carrier may be embodied by a computer program product. The computer program product includes a computer-readable storage medium, such as the non-volatile storage medium, and computer-readable program code portions, such as a series of computer instructions, embodied in the computer-readable storage medium. Typically, the computer program is stored by a memory device and executed by an associated processing unit, such as the processing element of the server.

In this regard, FIGS. 1 and 2 are flowcharts of methods and program products according to the invention. It will be understood that each step of the flowchart, and combinations of steps in the flowchart, can be implemented by computer program instructions. These computer program instructions may be loaded onto one or more computers or other programmable apparatus to produce a machine, such that the instructions which execute on the computer or other programmable apparatus create means for implementing the functions specified in the flowchart step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the flowchart step(s).

Accordingly, steps of the flowchart support combinations of means for performing the specified functions, combinations of steps for performing the specified functions and program instruction means for performing the specified functions. It will also be understood that each step of the flowchart, and combinations of steps in the flowchart, can be implemented by special purpose hardware-based computer systems which perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of accessing an electronic ticket by a paper-based carrier comprising:
receiving a first request document in a first format at an intermediate location in response to a request by the paper-based carrier to access the electronic ticket;
converting the first request document to at least one second request document in a second format, different than the first format, at the intermediate location; and
transmitting the second request document from the intermediate location to an electronic ticket database to thereby direct the electronic ticket database to access the electronic ticket in response to the second request document.

2. The method of claim 1, wherein the method further comprises:
receiving a first response document in the second format from the electronic ticket database;
converting the first response document to a second response document using the first format, wherein the first response document and the second response document each comprise electronic ticket data; and
transmitting the second response document to the paper-based carrier.

3. The method of claim 1, wherein the first format is XML and the second format is EDIFACT.

4. The method of claim 1, wherein the request by the paper-based carrier comprises at least one search term, such that the electronic ticket database uses the search term to access the electronic ticket.

5. The method of claim 2, further comprising displaying a facsimile of a paper ticket.

6. The method of claim 1, wherein receiving the first request document is further in response to a request by the paper-based carrier to change a status of the electronic ticket; and wherein the first request document and the second request document each comprise instructions to change the status of the electronic ticket to thereby direct the electronic ticket database to change the status of the electronic ticket in response to the second request document.

7. The method of claim 1, wherein receiving the first request document is in response to a request by the paper-based carrier to change a status of each of a plurality of electronic tickets; wherein the first request document is converted to a plurality of second request documents; and wherein the first request document and the second request documents each comprise instructions to change the status of the electronic ticket to thereby direct the electronic ticket database to change the status of each of the plurality of electronic tickets in response to the plurality of second request documents.

8. The method of claim 7, wherein the plurality of electronic tickets correspond to a flight of the paper-based carrier, and wherein the method further comprises requiring the paper-based carrier to change the status of each of the plurality of electronic tickets after a departure of the flight.

9. A method of accessing an electronic ticket by a paper-based carrier comprising:
receiving electronic ticket data in a first format at an intermediate location from an electronic ticket database;
converting the electronic ticket data from the first format to a second format, different than the first format;
receiving a request document in the second format at an intermediate location in response to a request by the paper-based carrier to access the electronic ticket data;
accessing the electronic ticket data at the intermediate location in response to the request document;
creating a response document in the second format, the response document comprising the electronic ticket data; and
transmitting the response document from the intermediate location to the paper-based carrier.

10. The method of claim 9, wherein the first format is EDIFACT and the second format is XML.

11. The method of claim 9, wherein the request by the paper-based carrier comprises at least one search term, such that the search term is used to access the electronic ticket data.

12. The method of claim 9, further comprising displaying a facsimile of a paper ticket.

13. A system for accessing an electronic ticket by a paper-based carrier comprising:
a processing element capable of receiving a first request document in a first format at an intermediate network location in response to a request by the paper-based carrier to access the electronic ticket; the processing element further capable of converting the first request document to at least one second request document in a second format, different than the first format, at the intermediate network location; the processing element further capable of transmitting the second request document from the intermediate network location to an electronic ticket database to thereby direct the electronic ticket database to access the electronic ticket in response to the second request document.

14. The system of claim 13, wherein the processing element is further capable of receiving a first response document in the second format from the electronic ticket database; wherein the processing element is further capable of converting the first response document to a second response document using the first format; wherein the processing element is further capable of transmitting the second response document to the paper-based carrier; and wherein the first response document and the second response document each comprise the electronic ticket data.

15. The system of claim 14, further comprising a client capable of creating the first request document in a first format and transmitting the first request document to the intermediate network location, the client further capable of receiving the second response document.

16. The system of claim 14, further comprising a ticket database capable of receiving the second request document from the intermediate network location and accessing the electronic ticket in response to the second request document, the ticket database further capable of creating the first response document in the second format and transmitting the first response document to the intermediate network location.

17. The system of claim 13, wherein the first format is XML and the second format is EDIFACT.

18. The system of claim 13, wherein the request by the paper-based carrier comprises at least one search term, such that the electronic ticket database uses the search term to access the electronic ticket.

19. The system of claim 15, wherein the client further comprises a display element capable of displaying a facsimile of a paper ticket.

20. The system of claim 13, wherein the processing element receives the first request document in response to a request by the paper-based carrier to change a status of the electronic ticket; and wherein the first request document and the second request document each comprise instructions to change the status of the electronic ticket to thereby direct the electronic ticket database to change the status of the electronic ticket in response to the second request document.

21. The system of claim 13, wherein the processing element receives the first request document in response to a request by the paper-based carrier to change a status of each of a plurality of electronic tickets; wherein the processing element converts the first request document to a plurality of second request documents; and wherein the first request document and the second request documents each comprise instructions to change the status of the electronic ticket to thereby direct the electronic ticket database to change the status of each of the plurality of electronic tickets in response to the plurality of second request documents.

22. The system of claim 21, wherein the plurality of electronic tickets correspond to a flight of the paper-based carrier, and wherein the processing element is further capable of requiring the paper-based carrier to change the status of each of the plurality of electronic tickets after a departure of the flight.

23. A system for accessing an electronic ticket by a paper-based carrier comprising:
a processing element capable of receiving electronic ticket data in a first format at an intermediate network location from an electronic ticket database; the processing element further capable of converting the electronic ticket data from the first format to a second format, different than the first format; the processing element further capable of receiving a request document in the second format at the intermediate network location in response to a request by the paper-based carrier to access the electronic ticket data; the processing element further capable of accessing the electronic ticket data at the intermediate network location in response to the request document; the processing element further capable of creating a response document in the second format, the response document comprising the electronic ticket data; and the processing element further capable of transmitting the response document from the intermediate network location to the paper-based carrier.

24. The system of claim 23, further comprising a client capable of creating the request document in a first format and transmitting the request document to the intermediate network location, the client further capable of receiving the response document.

25. The system of claim 23, further comprising a ticket database capable of transmitting electronic ticket data in a first format to an intermediate network location.

26. The system of claim 23, wherein the first format is EDIFACT and the second format is XML.

27. The system of claim 23, wherein the request by the paper-based carrier comprises at least one search term, such that the search term is used to access the electronic ticket data.

28. The system of claim 24, wherein the client further comprises a display element capable of displaying a facsimile of a paper ticket.

29. A computer program product for accessing an electronic ticket by a paper-based carrier, the computer program product comprising at least one computer-readable storage medium having computer-readable program code portions stored therein, the computer-readable program code portions comprising:
a first executable portion capable of receiving a first request document in a first format at an intermediate location in response to a request by the paper-based carrier to access the electronic ticket;
a second executable portion capable of converting the first request document to at least one second request document in a second format, different than the first format, at the intermediate location; and
a third executable portion capable of transmitting the second request document from the intermediate location to an electronic ticket database to thereby direct the electronic ticket database to access the electronic ticket in response to the second request document.

30. The computer program product of claim 29, wherein the computer program product further comprises a fourth executable portion capable of receiving a first response document in the second format from the electronic ticket database, converting the first response document to a second response document using the first format, and transmitting the second response document to the paper-based carrier; and wherein the first response document and the second response document each comprise electronic ticket data.

31. The computer program product of claim 29, wherein the first format is XML and the second format is EDIFACT.

32. The computer program product of claim 29, wherein the request by the paper-based carrier comprises at least one search term, such that the electronic ticket database uses the search term to access the electronic ticket.

33. The computer program product of claim 30, further comprising a fifth executable portion capable of displaying a facsimile of a paper ticket.

34. The computer program product of claim 29, wherein the first executable portion receives the first request document in response to a request by the paper-based carrier to change a status of the electronic ticket; and wherein the first request document and the second request document each comprise instructions to change the status of the electronic ticket to thereby direct the electronic ticket database to change the status of the electronic ticket in response to the second request document.

35. The computer program product of claim 29, wherein the first executable portion receives the first request document in response to a request by the paper-based carrier to change a status of each of a plurality of electronic tickets; wherein the second executable portion converts the first request document to a plurality of second request documents; and wherein the first request document and the second request documents each comprise instructions to change the status of the electronic ticket to thereby direct the electronic ticket database to change the status of each of the plurality of electronic tickets in response to the plurality of second request documents.

36. The computer program product of claim 35, wherein the plurality of electronic tickets correspond to a flight of the paper-based carrier, and wherein the computer program product further comprises a fourth executable element capable of requiring the paper-based carrier to change the status of each of the plurality of electronic tickets after a departure of the flight.

37. A computer program product for accessing an electronic ticket by a paper-based carrier, the computer program product comprising at least one computer-readable storage medium having computer-readable program code portions stored therein, the computer-readable program code portions comprising:
a first executable portion capable of receiving electronic ticket data in a first format at an intermediate location from an electronic ticket database;
a second executable portion capable of converting the electronic ticket data from the first format to a second format, different than the first format;
a third executable portion capable of receiving a request document in the second format at the intermediate location in response to a request by the paper-based carrier to access the electronic ticket data;
a fourth executable portion capable of accessing the electronic ticket data at the intermediate location in response to the request document;
a fifth executable portion capable of creating a response document in the second format, the response document comprising the electronic ticket data; and
a sixth executable portion capable of transmitting -the response document from the intermediate location to the paper-based carrier.

38. The computer program product of claim 37, wherein the first format is EDIFACT and the second format is XML.

39. The computer program product of claim 37, wherein the request by the paper-based carrier comprises at least one search term, such that the search term is used to access the electronic ticket data.

40. The computer program product of claim 37, further comprising a seventh executable portion capable of displaying a facsimile of a paper ticket.
